(19) United States
(12) Patent Application Publication
(10) Pub. No.: US 2016/0044249 A1
(43) Pub. Date: Feb. 11, 2016

(54) NETWORK CAMERA THAT CONNECTS A PLURALITY OF EXTENSIBLE IMAGERS

(71) Applicant: Brickcom Corporation, Hsinchu (TW)

(72) Inventors: CI-FANG SYU, Hsinchu (TW); SHANG-FENG HUANG, Hsinchu (TW); CHENG-KANG TSENG, Hsinchu (TW); HUNG-HSIANG CHENG, Hsinchu (TW)

(21) Appl. No.: 14/452,030

(22) Filed: Aug. 5, 2014

(51) Int. Cl. H04N 5/247; H04N 5/232; H04N 7/18

(52) U.S. Cl. CPC H04N 5/247; H04N 7/181; H04N 5/23229

(57) ABSTRACT

A network camera that connects a plurality of extensible imagers includes at least one imaging module and a camera body. The at least one imaging module includes a lens, an image sensor, an image digital signal processor with a video encoder and a USB connecting line. The camera body includes a plurality of USB ports for the USB signal line of the at least one imaging module to insert therein, a CPU and at least one signal output interface. The image sensor captures a digital image via the lens. The digital image is processed by the image digital signal processor and the video encoder and transmitted to the camera body via the USB connecting line. The digital image is further processed by computations of the CPU to form required signals outputted via the signal output interface.

### FIELD OF THE INVENTION

The present invention relates to a network camera, and particularly to a network camera that connects a plurality of extensible imagers.

### BACKGROUND OF THE INVENTION

Referring to FIG. 1 and FIG. 2 showing a structure and a system architecture of a conventional network camera, the conventional network camera is designed in a way that a camera body 1 has a Registered Jack 12 (RJ12) connector 2. The RJ12 connector 2 is for connecting to a cable 3 that connects to an image sensor 4 and a lens 5, enabling the lens 5 to extend to a desired position. The camera body 1 includes a digital image signal processor 6, a video encoder 7, a central processing unit (CPU) 8, at least one signal output interface 9, and a memory slot 10. An image formed at the image sensor 4 is digitalized and then converted to a real image recognizable by human eyes via the digital image signal processor 6. In addition to converting images, the digital image signal processor 6 is also capable of performing other advanced image processing functions, such as automatic white balance, automatic exposure and automatic focusing computations, and controls on the wide dynamic range (WDR), backlight compensation, aperture and shutter. That is, functions of video control are completed by the built-in digital image processor 6. Further, to compress and store a video file, the video encoder 7 may be selectively utilized. Different types of video encoders 7 adopt different compression methods for data compression. Each type of encoder has a corresponding decoder for decompressing and decoding data to be played. Common formats of data files include mpg, avi, mov, mp4, acc, rm and tta.

More specifically, in a current solution, an image is captured through the lens 5 for the image sensor 4 to generate image data. The image data is transmitted via the cable 3 to the image digital signal processor 6 and the video encoder 7 at the camera body 1, processed by the digital signal image processor 6, and compressed and encoded by the video encoder 7 to fully digitalize the image data. After the undergoing computations of the CPU 8, the image data may form required network signals that are then outputted via the at least one signal output interface 9. The at least one signal output interface 9 includes an RJ45 network connector 12 and a digital image output port 13. Alternatively, the fully digitalized image data may be stored in a memory card inserted in the memory card slot 10.

In the above structure of the conventional network camera, the lens 5 and the image sensor 4 are combined into an extremely small independent unit, which may be separated from the camera body 1 and connected thereto by the cable 3 However, the above structure allows the camera body 1 to connect to only one set of extensible lens. Instead of simultaneously monitoring distant images in different viewing angles, the structure of the conventional network camera is capable of monitoring merely a distant image in one single viewing angle, and thus cannot meet user's needs. Further, the RJ12 connector 2 which is conventionally utilized to connect to the cables 3 is in a special specification and provides inadequate versatility.

### SUMMARY OF THE INVENTION

The primary object of the present invention is to provide a network camera that connects a plurality of extensible imagers and is capable of monitoring distant images in different angles. To achieve the above object, a network camera that connects a plurality of extensible imagers to provide a plurality of different simultaneous views according to an embodiment of the present invention includes at least one imaging module and a camera body. The at least one imaging module includes a lens, an image sensor, an image digital signal processor, a video encoder and an USB connecting line. The camera body includes a plurality of USB ports for the USB connecting line of the at least one imaging module to insert therein, a central processing unit (CPU) and at least one signal output interface; The image sensor captures a digital image via the lens. The digital image is processed by the image digital signal processor, and compressed and encoded by the video encoder. The processed digital image is transmitted to the camera body via the USB connecting line, and then being further processed by computations of the CPU to form required signals outputted via the signal output interface.

Accordingly, through disposing the plurality of USB ports on the camera body of the present invention, the USB connecting line of the at least one imaging module may be inserted in the USB ports to allow the at least one imaging module to be connected to the camera body. As such, the camera body is enabled to simultaneously obtain distant images of different viewing angles to satisfy utilization requirements.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a structure of a conventional network camera;

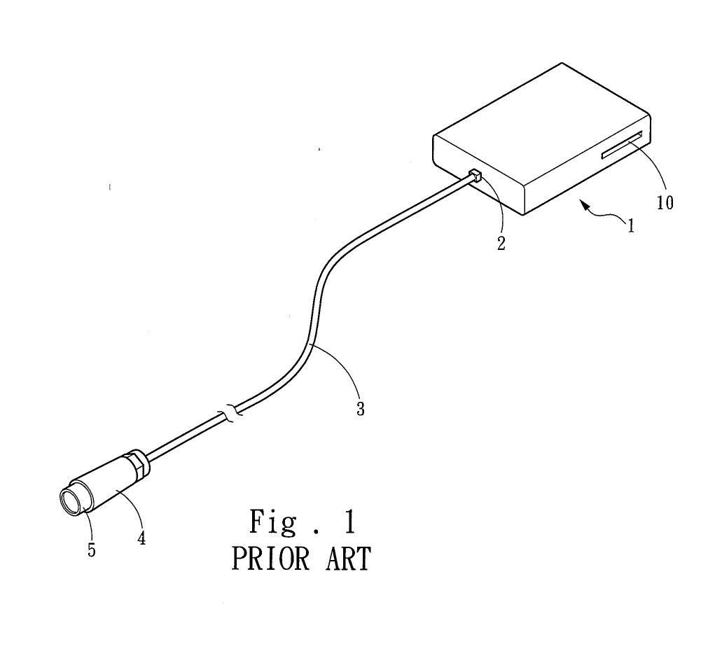

FIG. 2 is a system architecture of the conventional network camera;

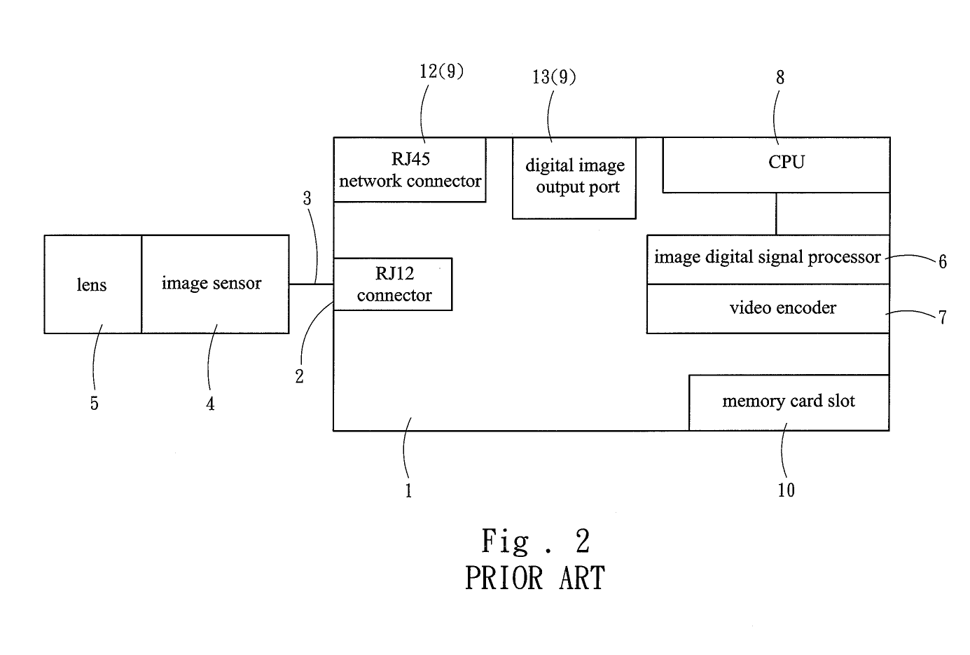

FIG. 3 is a system architecture according to an embodiment of the present invention; and

FIG. 4 is a structure of a network camera according to an embodiment of the present invention.

### DETAILED DESCRIPTION OF THE PREFERRED EMBODIMENTS

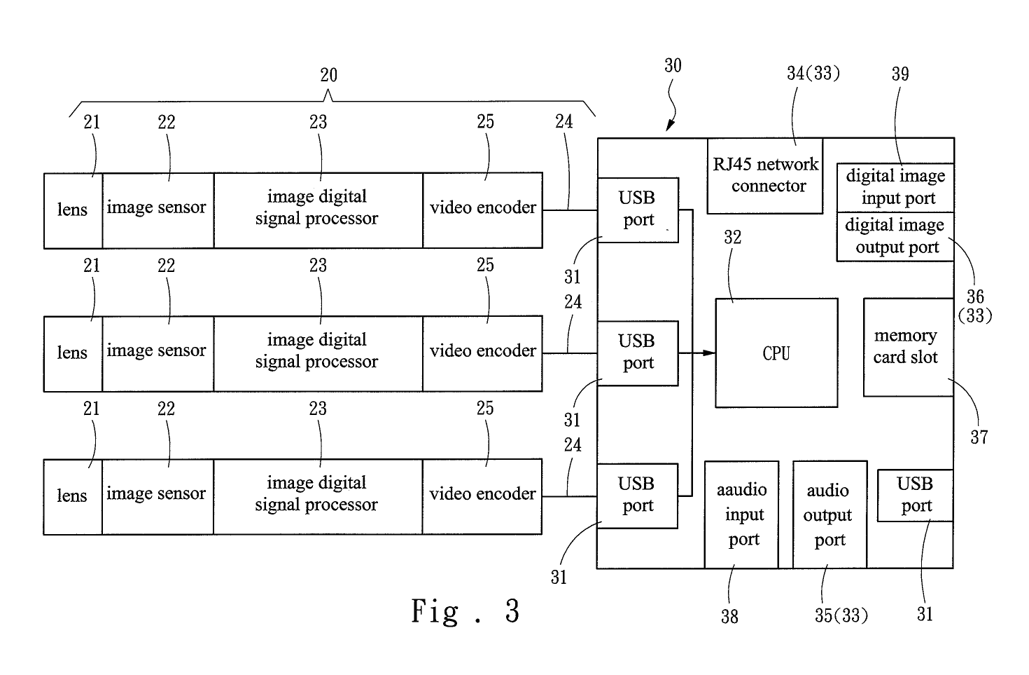

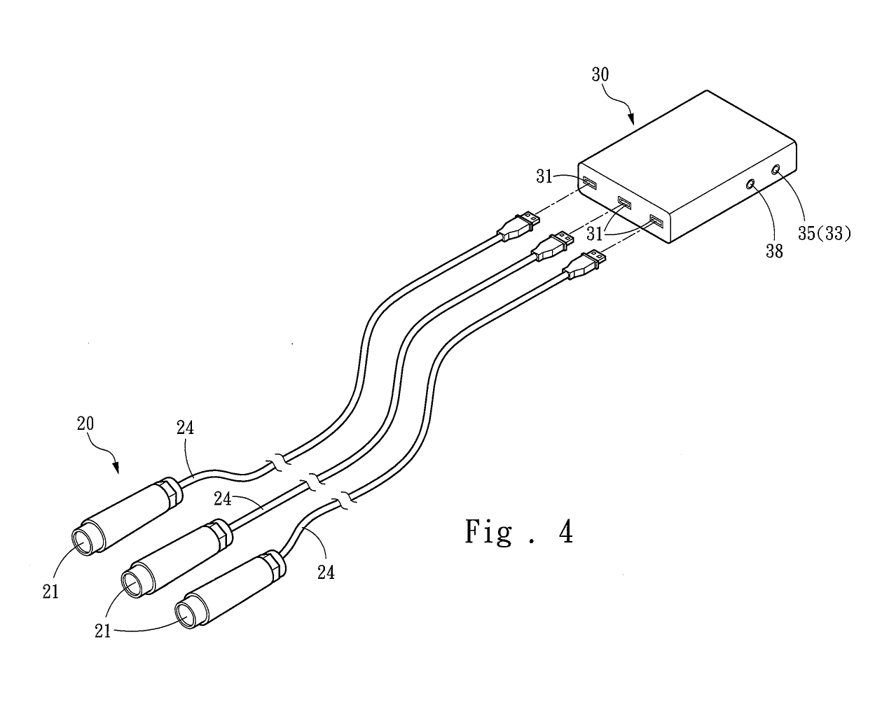

Referring to FIG. 3 and FIG. 4, a network camera that connects a plurality of extensible imagers to provide multiple different simultaneous views is provided by the present invention. The network camera includes at least one imaging module 20 and a camera body 30. The at least one imaging module 20 includes a lens 21, an image sensor 22, an image digital signal processor 23 for performing image processing, a video encoder 25, and a USB connecting line 24. The camera body 30 includes a plurality of USB ports 31, a CPU 32, and at least one signal output interface 33. The plurality of USB ports 31 may be inserted by the USB connecting line 24 of the at least one imaging module 20. The image sensor 22 captures a digital image via the lens 21. The digital image is processed by the image digital signal processor 23, and compressed and encoded by the video encoder 25. The processed digital image is transmitted to the camera body 30 via the USB connecting line 24. Further, after undergoing computations of the CPU 32, the digital image may form required signals and be outputted via the signal output interface 33.

The image compression and encoding performed by the video encoder 25 are mainly for reducing a file size of image data. That is, the video encoder 25 compresses the digital image and converts a storage format of the digital image to reduce the file size of the image data.

Further, the at least one signal output interface 33 may further include an RJ45 network connector 34, via which the digital image is outputted to the Internet or an internal network. The at least one signal output interface 33 may further include an audio output port 35 for outputting audio signals and a digital image output port 36 for outputting digital images that can be played by a display device having a corresponding interface. The camera body 30 may further include a memory card slot 37, in which a memory card, e.g., an SD or Micro-SD card, may be inserted.

The camera body 30 may further include an audio input port 38 and a digital image input port 39. The audio input port 38 may be externally connected to a sound collecting element, e.g., a microphone, for obtaining external sounds. The digital image input port 39 may be externally connected to an image input device, e.g., a multimedia player, a video camera and a camera, for additionally inputting image data. It should be noted that, the number of the plurality of USB ports 31 is larger than the number of the at least one imaging module 20. For example, as depicted in the diagram, the number of the at least one imaging module 20 is three, and the number of the multiple USB ports 31 is four. Thus, the remaining available USB port 31 may connect to other USB device to provide an expansion function.

In conclusion, with the USB ports provided in the present invention, the USB connecting line of the at least one imaging module may be inserted into any of the USB ports to allow the at least one imaging module to be connected to the camera body. In other words, in the present invention, given the at least one imaging module is placed at different angles and positions, distant images of different viewing angles may be obtained by the at least one imaging module to satisfy utilization requirements.

The present invention offers following features. First of all, by connecting with the USB connecting line, a signal amplifier may be additionally installed to extend a usable distance of the USB connecting line for more readily acquiring images of different viewing angles.

Through the USB port, the at least one imaging module that connects to the camera body provides a hot plugging function. As such, the at least one imaging module may be additionally installed or removed to enhance the ease-of-use without rebooting. Further, USB-related cables are common attainable and thus provides enhanced versatility.

Further, the present invention is a one-to-many design which is connectable to a plurality of imaging modules to satisfy requirements of obtaining distant images of different viewing angles, thereby improving drawbacks of a conventional one-on-one design. On top of satisfying the requirement of obtaining multiple images and being compared to the conventional solution, the present invention reduces costs of human resources, time and costs for installing and maintaining the imaging devices.

Moreover, in the present invention, through the collaboration of a plurality of imaging modules, an all-directional 360-degree monitoring effect is achieved to satisfy utilization requirements.

What is claimed is:

1. A network camera that connects a plurality of imagers, comprising:
at least one imaging module, comprising a lens, an image sensor, an image digital signal processor, a video encoder, and a USB connecting line; and
a camera body, comprising a plurality of USB ports for the USB connecting line of the at least one imaging module to insert therein, a central processing unit (CPU) and at least one signal output interface;
wherein the image sensor captures a digital image via the lens; the digital image being processed by the image digital signal processor, and compressed and encoded by the video encoder, and transmitted to the camera body via the USB connecting line, and then being further processed by computations of the CPU to form required signals outputted via the signal output interface.

2. The network camera of claim 1, wherein the at least one signal output interface further comprises a Registered Jack 45 (RJ45) network connector.

3. The network camera of claim 1, wherein the at least one signal output interface further comprises an audio output port.

4. The network camera of claim 1, wherein the at least one signal output interface further comprises a digital image output port.

5. The network camera of claim 1, wherein the camera body further comprises an audio input port.

6. The network camera of claim 1, wherein the camera body further comprises a memory card slot.

7. The network camera of claim 1, wherein the camera body further comprises a digital image input port.
